(19) United States
(12) Patent Application Publication
(10) Pub. No.: US 2025/0116549 A1
(43) Pub. Date: Apr. 10, 2025

(54) SIGNAL PROCESSING APPARATUS, SIGNAL PROCESSING METHOD, AND NON-TRANSITORY COMPUTER READABLE MEDIUM

(71) Applicant: NEC Corporation, Minato-ku, Tokyo (JP)

(72) Inventors: Wataru Kohno, Tokyo (JP); Sakiko Mishima, Tokyo (JP); Reishi Kondo, Tokyo (JP); Tomoyuki Hino, Tokyo (JP)

(73) Assignee: NEC Corporation, Minato-ku, Tokyo (JP)

(21) Appl. No.: 18/836,039

(22) PCT Filed: Mar. 31, 2022
(86) PCT No.: PCT/JP2022/016466

§ 371 Date: Aug. 6, 2024

(51) Int. Cl. G01H 9/00; G01D 5/353

(52) U.S. Cl. CPC G01H 9/006; G01D 5/35361

(57) ABSTRACT

Provided is a signal processing apparatus including: an acquisition unit configured to acquire a phase difference signal of backscattered light of laser light, by an optical fiber sensor configured to convert dynamic distortion of an optical fiber, at a first gauge length that is a predetermined section, into a phase difference of the backscattered light of the laser light passing through the first gauge length; and a control unit configured to perform signal processing to obtain phase difference data of the backscattered light of the laser light at a second gauge length shorter than the first gauge length, from the acquired phase difference signal of the backscattered light of the laser light.

### TECHNICAL FIELD

The present disclosure relates to a signal processing apparatus, a signal processing method, and a non-transitory computer readable medium.

### BACKGROUND ART

A method for detecting an acoustic signal using an optical fiber as a sensor medium has been developed. Patent Literature 1 discloses measurement of vibration transmitted to an optical fiber using time domain reflectometry (OTDR: Optical Time Domain Reflectometry). When pulsed light as probe light is incident on the optical fiber, backscattered light is generated along with propagation of the pulsed light. The OTDR measures backscattered light generated at each position of the optical fiber in a longitudinal direction. The measurement of the vibration is obtained by observing a change in the phase of the backscattered light obtained by the OTDR. Such an optical fiber sensor is called a distributed acoustic sensor (DAS) or the like.

As illustrated in FIG. 9, when vibration is applied to the optical fiber, the optical fiber in the section is distorted. Therefore, a phase difference between the phase of the backscattered light at the start and the phase of the backscattered light at the end of a certain section (phase difference evaluation target section) changes by the amount of fiber distortion. In a non-vibration state, the phase difference of the backscattered light is constant such that

$$[ Mathematical formula 1 ]$$

$${φ}_{2} - {φ}_{1} = φ ,$$

whereas when vibration occurs,

$$[ Mathematical formula 2 ]$$

$${φ}_{2}^{′} - {φ}_{1}^{′} = φ + Δ φ$$

$$and$$

$$Δ φ$$

are added. The phase difference evaluation target section is referred to as a gauge length G. When the length of the optical fiber is d and a reference phase is

φ₀

a phase difference signal with the gauge length G

Δφ(d,t)
is represented as

$$[ Mathematical formula 3 ]$$

$$Δ L ( d , t ) ∝ Δ φ ( d , t ) = [ φ ( d , t ) − φ ( d − G , t ) ] − {φ}_{0} .$$

In a case where the gauge length is small as illustrated in the left diagram of FIG. 10, a section for evaluating a phase difference from a reference point to an observation point is short and a spatial resolution is high, but the signal-to-noise (SN: Signal Noise) ratio is small. On the other hand, in a case where the gauge length is large as illustrated in the right diagram of FIG. 10, the section for evaluating the phase difference from the reference point to the observation point is long, and the spatial resolution is low, but the SN ratio is large. Due to the trade-off between the SN ratio and the spatial resolution, it is necessary to appropriately set the gauge length according to an event to be detected (such as abnormal sound and earthquake) and a detection method (such as the direction and position estimation of the event).

### CITATION LIST

### Patent Literature

Patent Literature 1: International Patent Publication No. WO2020/194856

### SUMMARY OF INVENTION

### Technical Problem

Therefore, an object of the present disclosure is to provide a signal processing apparatus that restores phase difference data of backscattered light of laser light having an arbitrary small gauge length from a phase difference signal of backscattered light of laser light having a large predetermined gauge length.

### Solution to Problem

A signal processing apparatus according to the present disclosure is a signal processing apparatus including:
an acquisition unit configured to acquire a phase difference signal of backscattered light of laser light, by an optical fiber sensor configured to convert dynamic distortion of an optical fiber, at a first gauge length that is a predetermined section, into a phase difference of the backscattered light of the laser light passing through the first gauge length; and
a control unit configured to perform signal processing to obtain phase difference data of the backscattered light of the laser light at a second gauge length shorter than the first gauge length, from the acquired phase difference signal of the backscattered light of the laser light.

A signal processing method according to the present disclosure is a signal processing method including:
a step of acquiring a phase difference signal of backscattered light of laser light, by an optical fiber sensor configured to convert dynamic distortion of an optical fiber, at a first gauge length that is a predetermined section, into a phase difference of the backscattered light of the laser light passing through the first gauge length; and
a step of obtaining phase difference data of the backscattered light of the laser light at a second gauge length shorter than the first gauge length, from the acquired phase difference signal of the backscattered light of the laser light.

A non-transitory computer readable medium according to the present disclosure is a non-transitory computer readable medium having recorded thereon a program to cause a signal processing apparatus to execute:
a step of acquiring a phase difference signal of backscattered light of laser light, by an optical fiber sensor configured to convert dynamic distortion of an optical fiber, at a first gauge length that is a predetermined section, into a phase difference of the backscattered light of the laser light passing through the first gauge length; and
a step of obtaining phase difference data of the backscattered light of the laser light at a second gauge length shorter than the first gauge length, from the acquired phase difference signal of the backscattered light of the laser light.

### Advantageous Effects of Invention

According to the present disclosure, it is possible to provide the signal processing apparatus that restores phase difference data of backscattered light of laser light having an arbitrary small gauge length from a phase difference signal of backscattered light of laser light having a large predetermined gauge length.

### BRIEF DESCRIPTION OF DRAWINGS

FIG. 1 is a block diagram of an optical fiber sensor according to an example embodiment.

FIG. 2 is a diagram illustrating processing of a spatial difference and processing of a dummy signal according to the example embodiment.

FIG. 3 is a block diagram of a signal processing apparatus that restores phase difference data of backscattered light of laser light having a small gauge length from a phase difference signal of backscattered light of laser light having a large gauge length according to the example embodiment.

FIG. 4 is a flowchart of processing performed by a spatial difference data calculation unit according to the example embodiment.

FIG. 5 is a diagram illustrating application of spatial difference processing to a phase difference signal of backscattered light of laser light having a large gauge length according to the example embodiment.

FIG. 6 is a flowchart of processing performed by a dummy signal removal unit according to the example embodiment.

FIG. 7 is a diagram illustrating application of a spatial filter to spatial difference data according to the example embodiment.

FIG. 8 is a diagram of a signal obtained by applying the signal processing apparatus to a signal according to an example and that of a comparative example.

FIG. 9 is a diagram illustrating the principle of a related DAS.

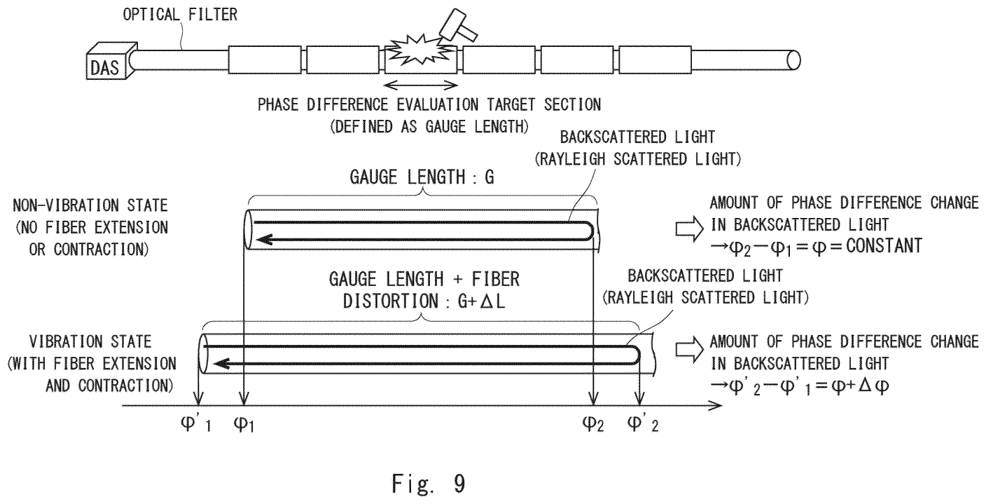

FIG. 10 is a diagram illustrating a trade-off between an SN ratio and spatial resolution in the related DAS.

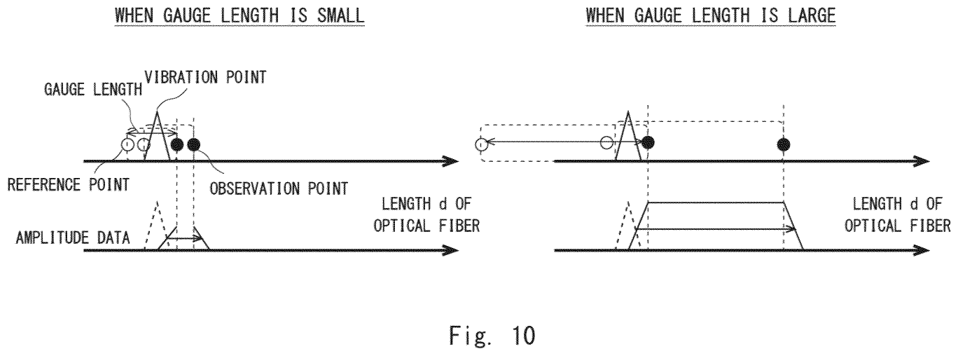

FIG. 11 is a block diagram of the signal processing apparatus according to the example embodiment.

### EXAMPLE EMBODIMENT

### Example Embodiment

Hereinafter, an example embodiment of the present invention will be described with reference to the drawings. However, the invention according to the claims is not limited to the following example embodiment. Not all the configurations described in the example embodiment are essential as means for solving the problem. To clarify description, in the following description and drawings, omission and simplification are made as appropriate. In the drawings, the same elements are denoted by the same reference numerals, and repeated description will be omitted as necessary.

### (Optical Fiber Sensor of Example Embodiment)

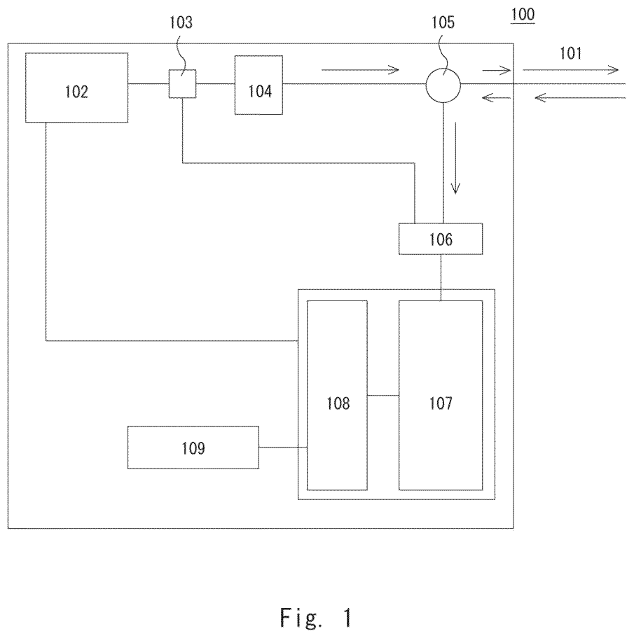

FIG. 1 is a block diagram of an optical fiber sensor according to the example embodiment. An optical fiber sensor 100 of the present example embodiment will be described with reference to FIG. 1.

The optical fiber sensor 100 includes an optical fiber 101, a light source 102, an optical coupler 103, an optical modulator 104, a circulator 105, an optical detector 106, an acquisition unit 107, a control unit 108, and an output unit 109.

The optical fiber 101 is a linear cable that detects backscattered light (Rayleigh scattered light) of emitted laser light. The optical fiber 101 transmits light. As the optical fiber, a material capable of transmitting light, such as quartz glass or plastic formed in a fibrous shape, is used, and an optical fiber having a two-layer structure of a core in a center portion and a clad covering the periphery of the core is used. One end of the optical fiber is connected to the circulator 105. The optical fiber is connected and disposed at a place where vibration is desired to be detected.

The light source 102 is a laser light source having high coherence and a narrow line width. As the laser light source, a solid laser such as a ruby laser or a YAG laser, a liquid laser such as a dye laser, a gas laser such as an excimer laser or a CO₂ laser, a semiconductor laser, or the like can be used. The light source 102 oscillates pulsed light of a constant cycle toward the optical coupler 103 under the control of the control unit 108.

The optical coupler 103 is a device that branches the pulsed light output from the light source 102 into two. One of the pulsed lights branched by the optical coupler 103 is directed to the optical modulator 104, and the other is directed to the optical detector 106.

The optical modulator 104 is a device that modulates the pulsed light output from the light source 102. The optical modulator can change the wavelength, frequency, intensity, phase, and the like of light under the control of the control unit 108. The pulsed light modulated by the optical modulator 104 is output to the circulator 105.

The circulator 105 is a device that emits the pulsed light output from the optical modulator 104 toward the optical fiber 101. The circulator 105 outputs the backscattered light returned from the optical fiber toward the optical detector 106.

The optical detector 106 is a device that measures backscattered light by a coherent detection method. The pulsed light from the optical coupler 103 and the backscattered light from the circulator 105 are input to the optical detector 106. In the backscattered light, frequency shift occurs due to modulation of the pulsed light by the optical modulator 104, and thus light having different frequencies is simultaneously input to the optical detector 106. The optical detector 106 measures a beat frequency caused by interference between these two optical signals having different frequencies. The beat frequency measured by the optical detector 106 is output as analog data of the backscattered light toward an analog-to-digital converter of the acquisition unit 107. In this way, the phase difference of the backscattered light is detected. The reception timing of the backscattered light received by the optical detector 106 is synchronized with the timing of the pulsed light output from the light source 102 under the control of the control unit 108.

The acquisition unit 107 acquires a phase difference signal of the backscattered light of the laser light, by an optical fiber sensor that converts dynamic distortion of an optical fiber, at a first gauge length that is a predetermined section, into a phase difference of the backscattered light of the laser light passing through the first gauge length. The acquisition unit 107 is a device that includes a semiconductor integrated circuit or the like. The acquisition unit 107 processes the analog data related to the backscattered light output from the optical detector 106 together with the control unit 108. The acquisition unit 107 includes an analog-to-digital converter. The analog-to-digital converter is a device that converts analog data output from the optical detector 106 into digital data. The acquisition unit 107 processes the digital data in a known manner, which will not be described in detail herein.

Like the acquisition unit 107, the control unit 108 is a device that includes a semiconductor integrated circuit. The control unit 108 is a central arithmetic processing apparatus capable of executing a program. Here, the digital data of the acquisition unit 107 is controlled and processed. The control unit 108 includes a spatial difference data calculation unit 2 and a dummy signal removal unit 3.

The output unit 109 is a device such as a display apparatus or a speaker, and outputs data by display, voice, or the like.

### (Gauge Length Operation by Signal Processing)

It will be described that a signal in which the gauge length is changed can be obtained by taking the spatial difference data. When the phase difference signal of the backscattered light of the laser light having a first large gauge length G is

Δφ(d,t)
the spatial difference data at the same time as

Δφ(d−g,t)
in which a second small gauge length g is shifted in the optical fiber longitudinal direction is

$$[ Mathematical formula 4 ]$$

$$Δ φ ( d , t ) − Δ φ ( d − g , t ) = [ φ ( d , t ) − φ ( d − g , t ) ] − [ φ ( d − G , t ) − φ ( d − G − g , t ) ]$$

Here, the phase difference data

[symbol]

(d,t)
of the backscattered light of the laser light having the second gauge length is defined as

$$[ Mathematical formula 5 ]$$

$$[ φ ( d , t ) - φ ( d - g , t ) ] - {φ}_{0}^{′} = ( d , t ) .$$

Therefore, the spatial difference data is represented as

$$[ Mathematical formula 6 ]$$

$$Δ φ ( d , t ) - Δ φ ( d - g , t ) = ( d , t ) - ( d - G , t ) .$$

When the spatial difference data is taken, not only the phase difference data

[symbol]

(d,t)
of the backscattered light of the laser light having the second gauge length but also a dummy signal

− [symbol] (d−G,t)
is generated. It is difficult to remove this dummy signal by four arithmetic operations of data.

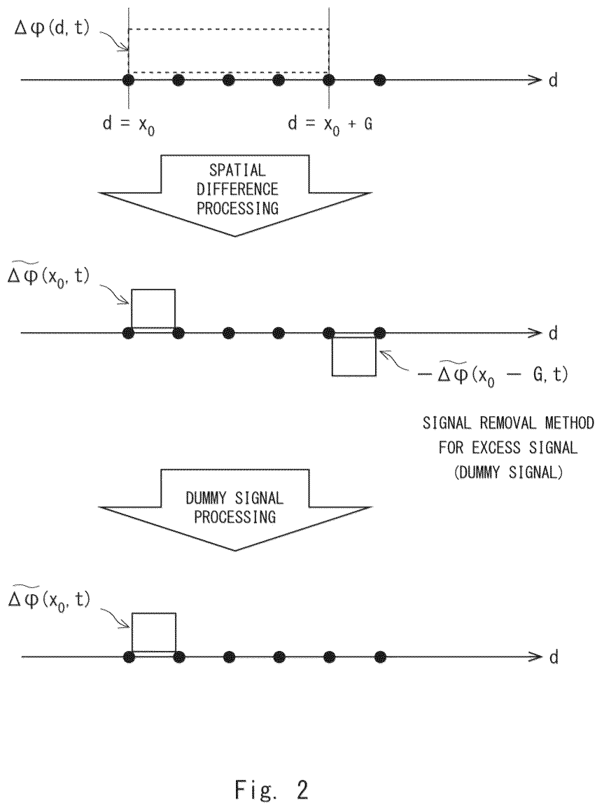

FIG. 2 is a diagram illustrating processing of a spatial difference and processing of a dummy signal according to the example embodiment. With reference to FIG. 2, the gauge length operation by the signal processing will be described as an image. As illustrated in the upper diagram of FIG. 2, the phase difference signal of the first gauge length G from a point x₀ to a point x₀+G is defined as

Δφ(d,t)

As illustrated in the middle diagram of FIG. 2, the phase difference data

[symbol]

(d,t)
of the second gauge length g and the dummy signal

− [symbol] (d−G,t)
are generated by taking the spatial difference. As illustrated in the lower diagram of FIG. 2, the dummy signal is removed by performing dummy signal processing on the spatial difference data, thereby obtaining

[symbol]

(d,t)

### (Signal Processing Apparatus According to Example Embodiment)

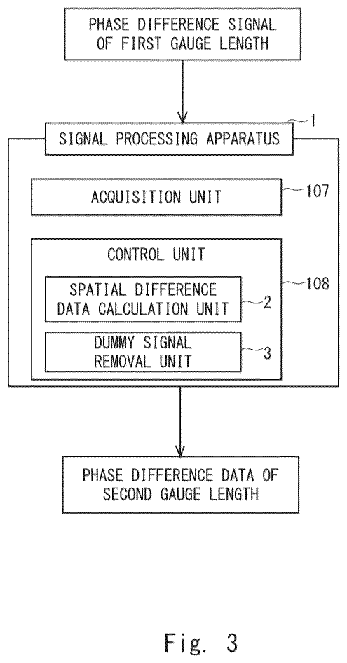

FIG. 3 is a block diagram of a signal processing apparatus that restores phase difference data of backscattered light of laser light having a small gauge length from a phase difference signal of backscattered light of laser light having a large gauge length according to the example embodiment. A signal processing apparatus according to the present example embodiment will be described with reference to FIG. 3.

A signal processing apparatus 1 of the present example embodiment restores the phase difference data of the backscattered light of the laser light having the second gauge length from the phase difference signal of the backscattered light of the laser light having the first gauge length. As illustrated in FIG. 3, the signal processing apparatus 1 of the present example embodiment includes the acquisition unit 107 and the control unit 108. The control unit 108 further includes the spatial difference data calculation unit 2 and the dummy signal removal unit 3. The spatial difference data indicates a spatial difference of the phase difference signal at a position shifted by the second gauge length g of the optical fiber in the longitudinal direction. In the spatial difference data calculation unit 2, the phase difference signal

Δφ(d,t)
of the first gauge length is input, and the second gauge length g is set. Then, in the spatial difference data calculation unit 2, the phase difference data

[symbol]

(d,t)
of the second gauge length is restored into a form including a dummy signal

− [symbol] (d−G,t)

The dummy signal removal unit 3 extracts and removes the dummy signal from the spatial difference data by signal processing. The output signal is the phase difference data

[symbol]

(d,t)
of the second gauge length.

### (Input Signal of Example Embodiment)

The phase difference signal

Δφ(p,q)
of the backscattered light of the laser light having the first gauge length that is the input signal of present example embodiment will be described. The input signal

Δφ(p,q)
is the phase difference signal (proportional to optical fiber distortion) or the phase difference temporal change signal (proportional to a distortion ratio) of the backscattered light (Rayleigh scattered light) with respect to the incident pulsed light obtained by a DAS.

Here, when d is a distance of the optical fiber from the optical fiber sensor to the measurement point, d is represented as

$$[ Mathematical formula 7 ]$$

$$d = p \times \frac{c}{2 \times {f}_{A D C}} = p \times {d}_{0} \qquad ( 1 )$$

p is an integer. f_{ADC} is a sampling frequency of the optical fiber sensor (here, a frequency of the analog-to-digital converter). c is represented as c=c₀/n_{c} and is the speed of light in the optical fiber when c₀ is the speed of light in vacuum, and n_{c} is the refractive index of the core of the optical fiber. d₀ is an interval between discrete points in the spatial direction.

When t is a measurement time, t is represented as

$$[ Mathematical formula 8 ]$$

$$t = q \times \frac{1}{{f}_{p u l s e}} \qquad ( 2 )$$

q is an integer, and f_{Pulse} is a frequency at which a pulse of laser light is emitted. Therefore, the first gauge length G is represented as G=Nd₀, and the second gauge length g is represented as g=nd₀, where N is an integer and n is an integer less than N.

### (Spatial Difference Data Calculation Unit of Example Embodiment)

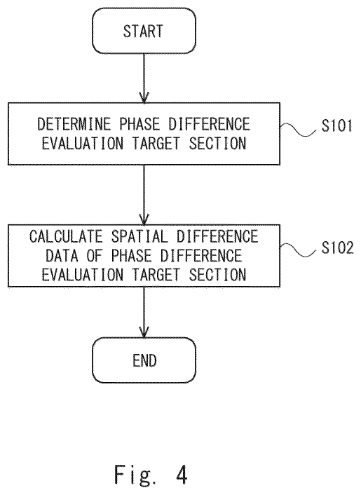

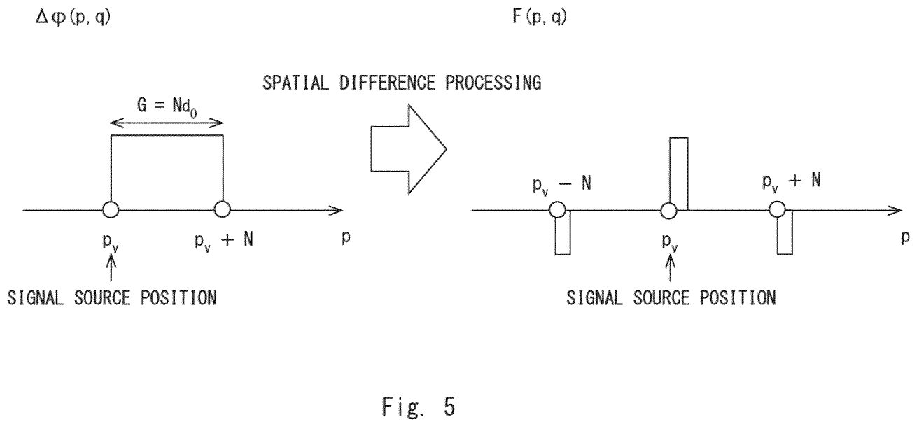

FIG. 4 is a flowchart of processing performed by the spatial difference data calculation unit according to the example embodiment. FIG. 5 is a diagram illustrating application of spatial difference processing to the phase difference signal of the backscattered light of the laser light having the large gauge length according to the example embodiment. The processing of the spatial difference data calculation unit of the present example embodiment will be described with reference to FIGS. 4 and 5.

As illustrated in FIG. 4, first, a phase difference evaluation target section is determined (S101). The phase difference evaluation target section is a space/time section to be evaluated in the measurement data, and p and q are determined from p₀≤p≤p₁ and q₀≤q≤q₁. For example, the phase difference evaluation target section is data for 0.1 seconds from a point 1 km to a point 2 km from the sensor. In addition, there may be a plurality of phase difference evaluation target sections, and for example, data for 10 seconds may be divided every 0.1 seconds, and all of them may be set as phase difference evaluation target sections.

Next, the spatial difference data of the phase difference evaluation target section is calculated (S102).

Here,

Δφ(p,q)

represents a phase difference signal of the backscattered light of the laser light having the first gauge length, and

[symbol]

(p,q)

represents phase difference data of the backscattered light of the laser light having the second gauge length.

Then, from

$$[ Mathematical formula 9 ]$$

$$f ( p , q ) = Δ φ ( p , q ) - Δ φ ( p - n , q ) = ( p , q ) - ( p - N , q ) \qquad ( 3 )$$

$$and$$

$$[ Mathematical formula 10 ]$$

$$\begin{matrix}- f ( p + N , q ) = - Δ φ ( p - n , q ) + Δ φ ( p + N - n , q ) , \\ = - ( p + N , q ) + ( p , q )\end{matrix} \qquad ( 4 )$$

the spatial difference data F(p,q) is obtained to be defined as

$$[ Mathematical formula 11 ]$$

$$\begin{matrix}F ( p , q ) = \frac{[ f ( p , q ) - f ( p + N , q ) ]}{2} \\ = ( p , q ) - \frac{( p - N , q )}{2} - \frac{( p + N , q )}{2}\end{matrix} \qquad ( 5 )$$

The above processing will be described with an image. As illustrated in the left diagram of FIG. 5,

Δφ(p,q)
is represented as a signal from a signal source position Pv in the phase difference evaluation target section to Pv+N corresponding to the first large gauge length G. When the spatial difference processing is performed, F(p,q) is represented as a signal from the signal source position Pv to Pv+n corresponding to the second small gauge length g and signals at positions Pv−N and Pv+N as illustrated in the right diagram of FIG. 5.

### (Dummy Signal Removal Unit of Example Embodiment)

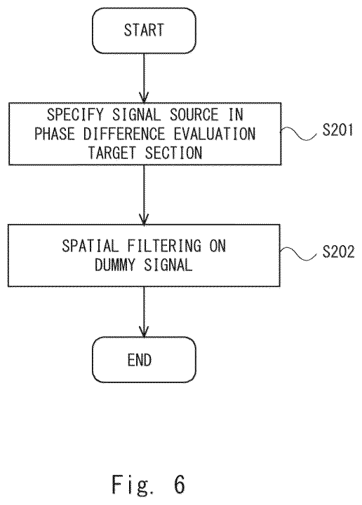

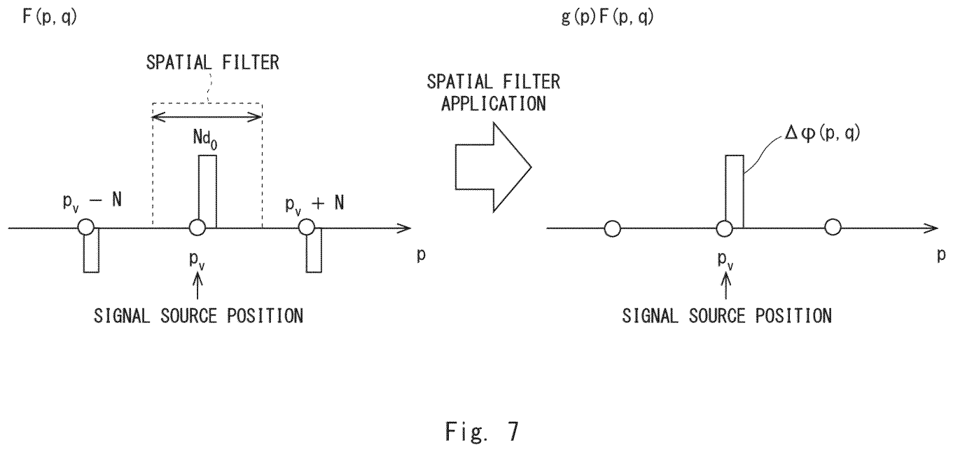

FIG. 6 is a flowchart of processing performed by the dummy signal removal unit according to the example embodiment. FIG. 7 is a diagram illustrating application of a spatial filter to the spatial difference data according to the example embodiment. The processing of the dummy signal removal unit of the present example embodiment will be described with reference to FIGS. 6 and 7.

As illustrated in FIG. 6, first, the position of the signal source in the phase difference evaluation target section is specified (S201). The position of the signal source refers to a length of a distribution of optical fibers from a DAS to a signal when the signal (for example, vibration on an optical fiber) derived from a certain signal source is detected by the DAS.

In order to obtain the position of the signal source in the phase difference evaluation target section for one signal source,

$$[ Mathematical formula 12 ]$$

$${F}_{m u l} ( P ) = {\sum }_{q = {q}_{0}}^{{q}_{1}} f ( p , q ) f ( p + N , q ) \qquad ( 6 )$$

is defined.

From

$$[ Mathematical formula 13 ]$$

$${F}_{m u l} ( P ) = {\sum }_{q = {q}_{0}}^{{q}_{1}} [ ( p , q ) - ( p - N , q ) ] [ ( p , q ) - ( p + N , q ) ] \approx {\sum }_{q = {q}_{0}}^{{q}_{1}} ( p , q ) , \qquad ( 7 )$$

Fₘᵤₗ(P)
is approximated to the sum of squares of the phase difference data of the second gauge length which is

$${\sum }_{q = {q}_{0}}^{{q}_{1}} ( p , q )$$

Therefore, Pₘₐₓ at which

Fₘᵤₗ(P)
takes the maximum value represents the position of the signal source. Pₘₐₓ is obtained from

$$[ Mathematical formula 14 ]$$

$${arg max}_{{p}_{0} \leq p \leq {p}_{1}} {F}_{mul} ( P ) = {P}_{max} \approx {arg max}_{{p}_{0} \leq p \leq {p}_{1}} {\sum }_{q = {q}_{0}}^{{q}_{1}} ( p , q ) \qquad ( 8 )$$

As illustrated in FIG. 6, next, spatial filtering is performed on the dummy signal (S202). The spatial filtering on the dummy signal can be performed by, for example, setting a window function g(p) having a width of about N centered around p=Pₘₐₓ and multiplying the window function g(p) by the spatial difference data F(p,q). As the window function, for example, a rectangular window, a Gaussian window, or a Hanning window can be used.

As the window function g(p) for filtering one signal source, the Hanning window is given as follows:

$$[ Mathematical formula 15 ]$$

$$g ( p ) = \{ \begin{matrix}1 − {sin}^{2} \frac{π ( p − {p}_{max} )}{N} \\ 0 , \text{} Otherwise\end{matrix} , \text{} \vert p − {p}_{max} \vert < \frac{G}{2} \qquad ( 9 )$$

The phase difference data of the backscattered light of the laser light of the second gauge length is obtained from

$$[ Mathematical formula 16 ]$$

$$( p , q ) \approx g ( p ) F ( p , q ) \qquad ( 10 )$$

The above processing will be described with an image. As illustrated in the right diagram of FIG. 7, a spatial filter of Nd₀ is applied to the signal source position Pv of the spatial difference data F(p,q). As illustrated in the left diagram of FIG. 7, the dummy signal disappears, and the phase difference data

[symbol]

(p,q)
of the backscattered light of the laser light having the second gauge length, which is the desired signal, is obtained.

In addition, a part or all of the processing in the signal processing apparatus 1 described above can be realized as a computer program. Such a program can be stored and supplied to the computer using various types of non-transitory computer readable media. Non-transitory computer readable media include various types of tangible storage media. Examples of non-transitory computer readable medium include a magnetic recording medium (for example, a flexible disk, a magnetic tape, or a hard disk drive), a magneto-optical recording medium (for example, a magneto-optical disc), a CD-read only memory (ROM) CD-R, a CD-R/W, and a semiconductor memory (for example, a mask ROM, a programmable ROM (PROM), an erasable PROM (EPROM), a flash ROM, and a random access memory (RAM)). In addition, the program may also be provided to a computer using various types of transitory computer readable media. Examples of transitory computer readable media include electric signals, optical signals, and electromagnetic waves. The transitory computer readable media can supply the programs to the computer via a wired communication path such as an electric wire and an optical fiber or a wireless communication path.

According to the present disclosure, it is possible to obtain the signal processing apparatus that restores phase difference data of backscattered light of laser light having an arbitrary small gauge length from a phase difference signal of backscattered light of laser light having a large predetermined gauge length. In addition, according to the present disclosure, it is possible to obtain the signal processing method for restoring phase difference data of backscattered light of laser light having an arbitrary small gauge length from a phase difference signal of backscattered light of laser light having a large predetermined gauge length. In addition, according to the present disclosure, it is possible to obtain a readable medium recording a program for performing processing of restoring phase difference data of backscattered light of laser light having an arbitrary small gauge length from a phase difference signal of backscattered light of laser light having a large predetermined gauge length.

### Example 1

An example in which the signal processing apparatus 1 of the present example embodiment is applied to a detection system for contact on an optical fiber will be described. The contact was made 5 times for 5 seconds at a point of a distance of 261 m to 262 m of the optical fiber from the DAS. The sampling frequency of the analog-to-digital converter is 125 MHz. The data of the gauge length of 24 m was restored to the data of the gauge length of 0.8 m by using the signal processing apparatus 1 of the present example embodiment.

A space 220 m≤d≤300 m and a time 0 sec≤t≤5 sec were set as the phase difference evaluation target section. As the window function, the Hanning window was used.

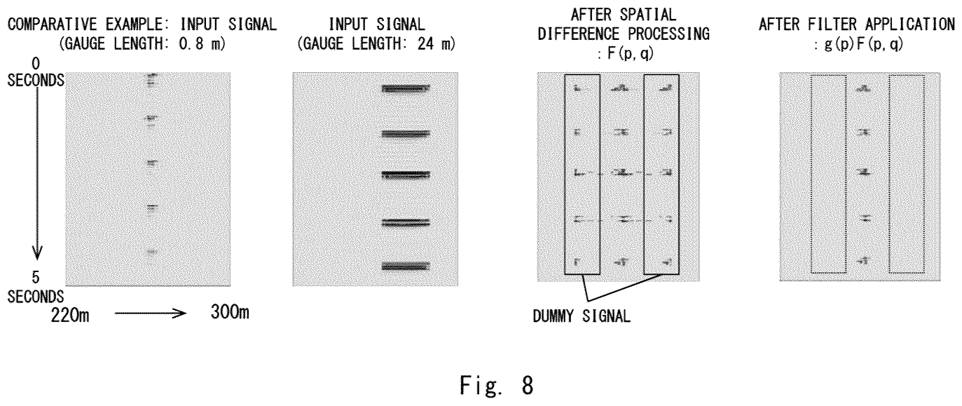

FIG. 8 is a diagram of a signal obtained by applying the signal processing apparatus to the signal according to the example and that of a comparative example. The leftmost diagram of FIG. 8 illustrates the comparative example which is an input signal having a gauge length of 0.8 m.

The second diagram from the left in FIG. 8 illustrates a phase difference signal of backscattered light of laser light which is an input signal having a gauge length of 24 m. As can be seen, a signal due to contact have been observed 5 times. In addition, the phase difference signal also has a large SN ratio. However, it can be seen that the signals are produced for a considerable period of time between 220 m and 300 m and the spatial resolution is poor.

The second diagram from the right in FIG. 8 is obtained by performing spatial difference processing on the phase difference signal. From this drawing, it can be seen that the spatial difference data F(p,q) after the spatial difference processing has dummy signals on both sides of the phase difference data of the backscattered light of the laser light.

The rightmost diagram in FIG. 8 is data after the spatial filter is applied to the spatial difference data. When the rightmost diagram of FIG. 8 after the filter application is compared with the leftmost diagram of the comparative example, it can be seen that almost the same data was obtained.

As described above, the signal processing apparatus according to the present example embodiment can restore the phase difference data of the backscattered light of the laser light having an arbitrary small gauge length from the phase difference signal of the backscattered light of the laser light having a large predetermined gauge length.

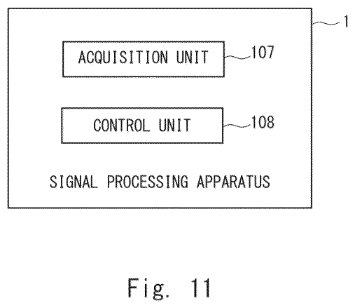

FIG. 11 is a block diagram of the signal processing apparatus according to the example embodiment. The signal processing apparatus according to the present example embodiment will be described with reference to FIG. 11.

The signal processing apparatus 1 according to the example embodiment includes the acquisition unit 107 that acquires a phase difference signal of the backscattered light of the laser light, by the optical fiber sensor that converts dynamic distortion of an optical fiber, at a first gauge length that is a predetermined section, into a phase difference of the backscattered light of the laser light passing through the first gauge length. Further, the signal processing apparatus 1 of the example embodiment includes the control unit 108 that obtains the phase difference data of the backscattered light of the laser light at a second gauge length shorter than the first gauge length, from the acquired phase difference signal of the backscattered light of the laser light.

The signal processing apparatus of the present example embodiment can restore the phase difference data of the backscattered light of the laser light having any an arbitrary gauge length from the phase difference signal of the backscattered light of the laser light having a large predetermined gauge length.

Although the example embodiment of the present invention has been described above, the present invention includes appropriate modifications without impairing the objects and advantages thereof, and is not limited by the above example embodiment.

Some or all of the above example embodiment may be described as the following supplementary notes but are not limited to the following.

### Supplementary Note 1

A signal processing apparatus including:
an acquisition unit configured to acquire a phase difference signal of backscattered light of laser light, by an optical fiber sensor configured to convert dynamic distortion of an optical fiber, at a first gauge length that is a predetermined section, into a phase difference of the backscattered light of the laser light passing through the first gauge length; and
a control unit configured to perform signal processing to obtain phase difference data of the backscattered light of the laser light at a second gauge length shorter than the first gauge length, from the acquired phase difference signal of the backscattered light of the laser light.

### Supplementary Note 2

The signal processing apparatus according to supplementary note 1, wherein
the control unit includes
a spatial difference data calculation unit configured to calculate spatial difference data indicating a spatial difference of a phase difference signal at a position shifted in a longitudinal direction of the optical fiber, and
a dummy signal removal unit configured to remove a dummy signal from the spatial difference data.

### Supplementary Note 3

The signal processing apparatus according to supplementary note 2, wherein
the spatial difference data calculation unit takes the spatial difference data of the phase difference signal at a position shifted by the first gauge length, and
the dummy signal removal unit specifies a position of a signal source in the predetermined section and filters the dummy signal.

### Supplementary Note 4

The signal processing apparatus according to supplementary note 3, wherein
in order to determine the first gauge length,
when d is a distance of the optical fiber from the optical fiber sensor to a measurement point, and is represented as

$$[ Mathematical formula 17 ]$$

$$d = p \times \frac{c}{2 \times {f}_{ADC}} = p \times {d}_{0} \qquad ( 1 )$$

where p is an integer, f_{ADC} is a sampling frequency of the optical fiber sensor, c is a speed of light in the optical fiber represented as c=c₀/n_{c} when c₀ is a speed of light in vacuum and n_{c} is a refractive index of a core of the optical fiber, and d₀ is an interval between discrete points in a spatial direction, and
t is a measurement time, and is represented as

$$[ Mathematical formula 18 ]$$

$$t = q \times \frac{1}{{f}_{pulse}} \qquad ( 2 )$$

where when q is an integer and f_{Pulse} is a frequency at which a pulse of the laser light is emitted,
the first gauge length G is represented as G=Nd₀,
the second gauge length g is represented as g=nd₀,
N is an integer, and n is an integer less than N, and
p and q are determined from p₀≤p≤p₁, q₀≤q≤q₁,
in order to take the spatial difference data of the phase difference signal at the position shifted by the first gauge length,
when

Δφ(p,q)
is the phase difference signal of the backscattered light of the laser light at the first gauge length, and

[symbol]

(p,q)
is the phase difference data of the backscattered light of the laser light at the second gauge length,
from

$$[ Mathematical formula 19 ]$$

$$f ( p , q ) = Δ φ ( p , q ) − Δ φ ( p − n , q ) = ( p , q ) − ( p − N , q ) \qquad ( 3 )$$

$$and$$

$$[ Mathematical formula 20 ]$$

$$\begin{matrix}- f ( p − N , q ) = - Δ φ ( p + N , q ) + Δ φ ( p + N - n , q ) , \\ = - ( p , q ) + ( p , q )\end{matrix} \qquad ( 4 )$$

the spatial difference data F(p,q) is obtained to be defined as

$$[ Mathematical formula 21 ]$$

$$\begin{matrix}F ( p , q ) = \frac{[ f ( p , q ) - f ( p + N , q ) ]}{2} , \\ = ( p , q ) - \frac{( p - N , q )}{2} - \frac{( p + N , q )}{2}\end{matrix} \qquad ( 5 )$$

in order to specify a position of the signal source in the predetermined section,

$$[ Mathematical formula 22 ]$$

$${F}_{m u l} ( P ) = - {\sum }_{q = {q}_{0}}^{{q}_{1}} f ( p , q ) f ( p + N , q ) \qquad ( 6 )$$

is defined, and
from

$$[ Mathematical formula 23 ]$$

$${F}_{m u l} ( P ) = {\sum }_{q = {q}_{0}}^{{q}_{1}} [ ( p , q ) - ( p - N , q ) ] [ ( p , q ) - ( p + N , q ) ] \approx {\sum }_{q = {q}_{0}}^{{q}_{1}} ( p , q ) , \qquad ( 7 )$$

Pₘₐₓ at which

Fₘᵤₗ(P)
takes a maximum value is obtained from

$$[ Mathematical formula 24 ]$$

$${arg max}_{{p}_{0} \leq p \leq {p}_{1}} {F}_{mul} ( P ) = {P}_{max} \approx {arg max}_{{p}_{0} \leq p \leq {p}_{1}} {\sum }_{q = {q}_{0}}^{{q}_{1}} ( p , q ) , \qquad ( 8 )$$

and
in order to filter the dummy signal,
a window function

$$[ Mathematical formula 25 ]$$

$$g ( p ) = \{ \begin{matrix}1 − {sin}^{2} \frac{π ( p − {p}_{max} )}{N} \\ 0 , \text{} Otherwise\end{matrix} , \text{} \vert p − {p}_{max} \vert < \frac{G}{2} \qquad ( 9 )$$

is used to obtain the phase difference data of the backscattered light of the laser light at the second gauge length represented as

$$[ Mathematical formula 26 ]$$

$$( p , q ) \approx g ( p ) F ( p , q ) \qquad ( 10 )$$

### Supplementary Note 5

A signal processing method including:
a step of acquiring a phase difference signal of backscattered light of laser light, by an optical fiber sensor configured to convert dynamic distortion of an optical fiber, at a first gauge length that is a predetermined section, into a phase difference of the backscattered light of the laser light passing through the first gauge length; and
a step of obtaining phase difference data of the backscattered light of the laser light at a second gauge length shorter than the first gauge length, from the acquired phase difference signal of the backscattered light of the laser light.

### Supplementary Note 6

The signal processing method according to supplementary note 5, wherein
the step of obtaining the phase difference data of the backscattered light of the laser light at the second gauge length includes
a step of calculating spatial difference data indicating a spatial difference of a phase difference signal at a position shifted in a longitudinal direction of the optical fiber, and
a step of removing a dummy signal from the spatial difference data.

### Supplementary Note 7

The signal processing method according to supplementary note 6, wherein
the step of calculating the spatial difference data includes a step of taking the spatial difference data of the phase difference signal at a position shifted by the first gauge length, and
the step of removing the dummy signal includes a step of specifying a position of a signal source in the predetermined section and filtering the dummy signal.

### Supplementary Note 8

The signal processing method according to supplementary note 7, wherein
in order to determine the first gauge length,
when d is a distance of the optical fiber from the optical fiber sensor to a measurement point, and is represented as

$$[ Mathematical formula 27 ]$$

$$d - p \times \frac{c}{2 \times {f}_{ADC}} = p \times {d}_{0} \qquad ( 1 )$$

where p is an integer, f_{ADC} is a sampling frequency of the optical fiber sensor, c is a speed of light in the optical fiber represented as c=c₀/n_{c} when c₀ is a speed of light in vacuum and n_{c} is a refractive index of a core of the optical fiber, and d₀ is an interval between discrete points in a spatial direction, and
t is a measurement time, and is represented as

$$[ Mathematical formula 28 ]$$

$$t = q \times \frac{1}{{f}_{pulse}} \qquad ( 2 )$$

where, when q is an integer and f_{Pulse} is a frequency at which a pulse of the laser light is emitted,
the first gauge length G is represented as G=Nd₀,
the second gauge length g is represented as g=nd₀,
N is an integer, and n is an integer less than N, and
p and q are determined from p₀≤p≤p₁, q₀≤q≤q₁,
in the step of taking the spatial difference data of the phase difference signal at the position shifted by the first gauge length,
when

Δφ(p,q)
is the phase difference signal of the backscattered light of the laser light at the first gauge length, and

[symbol]

(p,q)
is the phase difference data of the backscattered light of the laser light at the second gauge length,
from

$$[ Mathematical formula 29 ]$$

$$f ( p , q ) = Δ φ ( p , q ) − Δ φ ( p − n , q ) = ( p , q ) − ( p − N , q ) \qquad ( 3 )$$

$$[ Mathematical formula 30 ]$$

$$\begin{matrix}- f ( p + N , q ) = - Δ φ ( p + N , q ) + Δ φ ( p + N - n , q ) , \\ = - ( p + N , q ) + ( p , q )\end{matrix} \qquad ( 4 )$$

the spatial difference data F(p,q) is obtained to be defined as

$$[ Mathematical formula 31 ]$$

$$\begin{matrix}F ( p , q ) = \frac{[ f ( p , q ) - f ( p + N , q ) ]}{2} , \\ = ( p , q ) - \frac{( p - N , q )}{2} - \frac{( p - N , q )}{2}\end{matrix} \qquad ( 5 )$$

in the step of specifying a position of the signal source in the predetermined section,

$$[ Mathematical formula 32 ]$$

$${F}_{mul} ( P ) = {\sum }_{q = {q}_{0}}^{{q}_{1}} f ( p , q ) f ( p + N , q ) \qquad ( 6 )$$

is defined, and
from

$$[ Mathematical formula 33 ]$$

$${F}_{mul} ( P ) = {\sum }_{q = {q}_{0}}^{{q}_{1}} [ ( p , q ) − ( p − N , q ) ] [ ( p , q ) − ( p + N , q ) ] \approx {\sum }_{q = {q}_{0}}^{{q}_{1}} {2}^{} ( p , q ) , \qquad ( 7 )$$

Pₘₐₓ at which

Fₘᵤₗ(P)
takes a maximum value is obtained from

$$[ Mathematical formula 34 ]$$

$${arg max}_{{p}_{0} \leq p \leq {p}_{1}} {F}_{mul} ( P ) = {P}_{max} \approx {arg max}_{{p}_{0} \leq p \leq {p}_{1}} {\sum }_{q = {q}_{0}}^{{q}_{1}} ( p , q ) \qquad ( 8 )$$

and
in the step of filtering the dummy signal,
a window function

$$[ Mathematical formula 35 ]$$

$$g ( p ) = \{ \begin{matrix}1 − {sin}^{2} \frac{π ( p − {p}_{max} )}{N} \\ 0 , \text{} Otherwise\end{matrix} , \text{} \vert p − {p}_{max} \vert < \frac{G}{2} \qquad ( 9 )$$

is used to obtain the phase difference data of the backscattered light of the laser light at the second gauge length represented as

$$[ Mathematical formula 36 ]$$

$$( p , q ) \approx g ( p ) F ( p , q ) \qquad ( 10 )$$

### Supplementary Note 9

A non-transitory computer readable medium having recorded thereon a program to cause a signal processing apparatus to execute:
a step of acquiring a phase difference signal of backscattered light of laser light, by an optical fiber sensor configured to convert dynamic distortion of an optical fiber, at a first gauge length that is a predetermined section, into a phase difference of the backscattered light of the laser light passing through the first gauge length; and
a step of obtaining phase difference data of the backscattered light of the laser light at a second gauge length shorter than the first gauge length, from the acquired phase difference signal of the backscattered light of the laser light.

### Supplementary Note 10

The non-transitory computer readable medium having recorded thereon the program according to supplementary note 9, wherein
the step of obtaining the phase difference data of the backscattered light of the laser light at the second gauge length includes
a step of calculating spatial difference data indicating a spatial difference of a phase difference signal at a position shifted in a longitudinal direction of the optical fiber, and
a step of removing a dummy signal from the spatial difference data.

### Supplementary Note 11

The non-transitory computer readable medium having recorded thereon the program according to supplementary note 10, wherein
the step of calculating the spatial difference data includes a step of taking the spatial difference data of the phase difference signal at a position shifted by the first gauge length, and
the step of removing the dummy signal includes a step of specifying a position of a signal source in the predetermined section and filtering the dummy signal.

### Supplementary Note 12

The non-transitory computer readable medium having recorded thereon the program according to supplementary note 11, wherein
in order to determine the first gauge length,
when d is a distance of the optical fiber from the optical fiber sensor to a measurement point, and is represented as

$$[ Mathematical formula 37 ]$$

$$d - p \times \frac{c}{2 \times {f}_{ADC}} = p \times {d}_{0} \qquad ( 1 )$$

where p is an integer, f_{ADC} is a sampling frequency of the optical fiber sensor, c is a speed of light in the optical fiber represented as c=c₀/n_{c} when c₀ is a speed of light in vacuum and n_{c} is a refractive index of a core of the optical fiber, and d₀ is an interval between discrete points in a spatial direction, and
t is a measurement time, and is represented as

$$[ Mathematical formula 38 ]$$

$$t = q \times \frac{1}{{f}_{pulse}} \qquad ( 2 )$$

where, when q is an integer and f_{Pulse} is a frequency at which a pulse of the laser light is emitted,
the first gauge length G is represented as G=Nd₀,
the second gauge length g is represented as g=nd₀,
N is an integer, and n is an integer less than N, and
p and q are determined from p₀≤p≤p₁, q₀≤q≤q₁,
in the step of taking the spatial difference data of the phase difference signal at the position shifted by the first gauge length,
when

Δφ(p,q)
is the phase difference signal of the backscattered light of the laser light at the first gauge length, and

[symbol]

(p,q)
is the phase difference data of the backscattered light of the laser light at the second gauge length,
from

$$[ Mathematical formula 39 ]$$

$$f ( p , q ) = Δ φ ( p , q ) − Δ φ ( p − n , q ) = ( p , q ) − ( p − N , q ) \qquad ( 3 )$$

$$[ Mathematical formula 40 ]$$

$$\begin{matrix}- f ( p + N , q ) = - Δ φ ( p + N , q ) + Δ φ ( p + N - n , q ) , \\ = - ( p + N , q ) + ( p , q )\end{matrix} \qquad ( 4 )$$

the spatial difference data F(p,q) is obtained to be defined as

$$[ Mathematical formula 41 ]$$

$$\begin{matrix}F ( p , q ) = \frac{[ f ( p , q ) - f ( p + N , q ) ]}{2} , \\ = ( p , q ) - \frac{( p - N , q )}{2} - \frac{( p - N , q )}{2}\end{matrix} \qquad ( 5 )$$

in the step of specifying a position of the signal source in the predetermined section,

$$[ Mathematical formula 42 ]$$

$${F}_{mul} ( P ) = - {\sum }_{q = {q}_{0}}^{{q}_{1}} f ( p , q ) f ( p + N , q ) \qquad ( 6 )$$

$$is defined , and$$

$$from$$

$$[ Mathematical formula 43 ]$$

$${F}_{mul} ( P ) = {\sum }_{q = {q}_{0}}^{{q}_{1}} [ ( p , q ) − ( p − N , q ) ] [ ( p , q ) − ( p + N , q ) ] \approx {\sum }_{q = {q}_{0}}^{{q}_{1}} {2}^{} ( p , q ) , \qquad ( 7 )$$

Pₘₐₓ at which

Fₘᵤₗ(P)
takes a maximum value is obtained from

$$\begin{matrix}[ Mathematical formula 44 ] & \\ {arg max}_{{p}_{0} \leq p \leq {p}_{1}} {F}_{mul} ( P ) = {P}_{max} \approx {arg max}_{{p}_{0} \leq p \leq {p}_{1}} {\sum }_{q = {q}_{0}}^{{q}_{1}} ( p , q ) & ( 8 )\end{matrix}$$

and
in the step of filtering the dummy signal,
a window function

$$\begin{matrix}[ Mathematical formula 45 ] & \\ g ( p ) = \{ \begin{matrix}1 - {sin}^{2} \frac{π ( p - {p}_{max} )}{N} \\ 0 , Otherwise\end{matrix} , \vert p - {p}_{max} \vert < \frac{G}{2} & ( 9 )\end{matrix}$$

is used to obtain the phase difference data of the backscattered light of the laser light at the second gauge length represented as

$$\begin{matrix}[ Mathematical formula 46 ] & \\ Δφ ( p , q ) \approx g ( p ) F ( p . q ) & ( 10 )\end{matrix}$$

### REFERENCE SIGNS LIST

1 SIGNAL PROCESSING APPARATUS
2 SPATIAL DIFFERENCE DATA CALCULATION UNIT
3 DUMMY SIGNAL REMOVAL UNIT
100 OPTICAL FIBER SENSOR
101 OPTICAL FIBER
102 LIGHT SOURCE
103 OPTICAL COUPLER
104 OPTICAL MODULATOR
105 CIRCULATOR
106 OPTICAL DETECTOR
107 ACQUISITION UNIT
108 CONTROL UNIT
109 OUTPUT UNIT

What is claimed is:

1. A signal processing apparatus comprising:
an acquisition unit configured to acquire a phase difference signal of backscattered light of laser light, by an optical fiber sensor configured to convert dynamic distortion of an optical fiber, at a first gauge length that is a predetermined section, into a phase difference of the backscattered light of the laser light passing through the first gauge length; and
a control unit configured to perform signal processing to obtain phase difference data of the backscattered light of the laser light at a second gauge length shorter than the first gauge length, from the acquired phase difference signal of the backscattered light of the laser light.

2. The signal processing apparatus according to claim 1, wherein
the control unit includes
a spatial difference data calculation unit configured to calculate spatial difference data indicating a spatial difference of a phase difference signal at a position shifted in a longitudinal direction of the optical fiber, and
a dummy signal removal unit configured to remove a dummy signal from the spatial difference data.

3. The signal processing apparatus according to claim 2, wherein
the spatial difference data calculation unit takes the spatial difference data of the phase difference signal at a position shifted by the first gauge length, and
the dummy signal removal unit specifies a position of a signal source in the predetermined section and filters the dummy signal.

4. The signal processing apparatus according to claim 3, wherein
in order to determine the first gauge length,
when d is a distance of the optical fiber from the optical fiber sensor to a measurement point, and is represented as
$$\begin{matrix}[ Mathematical formula 47 ] & \\ d = p \times \frac{c}{2 \times {f}_{ADC}} = p \times {d}_{0} & ( 1 )\end{matrix}$$
where p is an integer, f_{ADC} is a sampling frequency of the optical fiber sensor, c is a speed of light in the optical fiber represented as c=c₀/n_{c} when c₀ is a speed of light in vacuum and n_{c} is a refractive index of a core of the optical fiber, and d₀ is an interval between discrete points in a spatial direction, and
t is a measurement time, and is represented as
$$\begin{matrix}[ Mathematical formula 48 ] & \\ t = q \times \frac{1}{{f}_{pulse}} & ( 2 )\end{matrix}$$
where, when q is an integer and f_{Pulse} is a frequency at which a pulse of the laser light is emitted,
the first gauge length G is represented as G=Nd₀,
the second gauge length g is represented as g=nd₀,
N is an integer, and n is an integer less than N, and
p and q are determined from p₀≤p≤p₁, q₀≤q≤q₁,
in order to take the spatial difference data of the phase difference signal at the position shifted by the first gauge length,
when
Δφ(p,q)
is the phase difference signal of the backscattered light of the laser light at the first gauge length, and [symbol]
(p,q)
is the phase difference data of the backscattered light of the laser light at the second gauge length,
from
$$\begin{matrix}[ Mathematical formula 49 ] & \\ f ( p , q ) = Δφ ( p , q ) - Δφ ( p - n , q ) = ( p , q ) - ( p - N , q ) & ( 3 )\end{matrix}$$
$$\begin{matrix}[ Mathematical formula 50 ] & \\ - f ( p + N , q ) = - Δφ ( p + N , q ) + Δφ ( p + N - n , q ) = - Δφ ( p + N , q ) + Δφ ( p , q ) & ( 4 )\end{matrix}$$
the spatial difference data F(p,q) is obtained to be defined as
$$\begin{matrix}[ Mathematical formula 51 ] & \\ F ( p , q ) = \frac{[ f ( p , q ) - f ( p + N , q ) ]}{2} = ( p , q ) - \frac{( p - N , q )}{2} - \frac{( p + N , q )}{2} & ( 5 )\end{matrix}$$
in order to specify a position of the signal source in the predetermined section,
$$\begin{matrix}[ Mathematical formula 52 ] & \\ {F}_{mul} ( P ) = - {\sum }_{q = {q}_{0}}^{{q}_{1}} f ( p , q ) f ( p + N , q ) & ( 6 )\end{matrix}$$
is defined, and
from
$$\begin{matrix}[ Mathematical formula 53 ] & \\ {F}_{mul} ( P ) = {\sum }_{q = {q}_{0}}^{{q}_{1}} [ ( p , q ) - ( p - N , q ) ] [ ( p , q ) - ( p + N , q ) ] \approx {\sum }_{q = {q}_{0}}^{{q}_{1}} {2}^{} ( p , q ) & ( 7 )\end{matrix}$$
Pₘₐₓ at which
Fₘᵤₗ(P)
takes a maximum value is obtained from
$$\begin{matrix}[ Mathematical formula 54 ] & \\ {arg max}_{{p}_{0} \leq p \leq {p}_{1}} {F}_{mul} ( P ) = {P}_{max} \approx {arg max}_{{p}_{0} \leq p \leq {p}_{1}} {\sum }_{q = {q}_{0}}^{{q}_{1}} ( p , q ) & ( 8 )\end{matrix}$$
and
in order to filter the dummy signal,
a window function
$$\begin{matrix}[ Mathematical formula 55 ] & \\ g ( p ) = \{ \begin{matrix}1 - {sin}^{2} \frac{π ( p - {p}_{max} )}{N} \\ 0 , Otherwise\end{matrix} , \vert p - {p}_{max} \vert < \frac{G}{2} & ( 9 )\end{matrix}$$
is used to obtain the phase difference data of the backscattered light of the laser light at the second gauge length represented as
$$\begin{matrix}[ Mathematical formula 56 ] & \\ Δφ ( p , q ) \approx g ( p ) F ( p . q ) & ( 10 )\end{matrix}$$

5. A signal processing method comprising:
a step of acquiring a phase difference signal of backscattered light of laser light, by an optical fiber sensor configured to convert dynamic distortion of an optical fiber, at a first gauge length that is a predetermined section, into a phase difference of the backscattered light of the laser light passing through the first gauge length; and
a step of obtaining phase difference data of the backscattered light of the laser light at a second gauge length shorter than the first gauge length, from the acquired phase difference signal of the backscattered light of the laser light.

6. The signal processing method according to claim 5, wherein
the step of obtaining the phase difference data of the backscattered light of the laser light at the second gauge length includes
a step of calculating spatial difference data indicating a spatial difference of a phase difference signal at a position shifted in a longitudinal direction of the optical fiber, and
a step of removing a dummy signal from the spatial difference data.

7. The signal processing method according to claim 6, wherein
the step of calculating the spatial difference data includes a step of taking the spatial difference data of the phase difference signal at a position shifted by the first gauge length, and
the step of removing the dummy signal includes a step of specifying a position of a signal source in the predetermined section and filtering the dummy signal.

8. The signal processing method according to claim 7, wherein
in order to determine the first gauge length,
when d is a distance of the optical fiber from the optical fiber sensor to a measurement point, and is represented as
$$\begin{matrix}[ Mathematical formula 57 ] & \\ d = p \times \frac{c}{2 \times {f}_{ADC}} = p \times {d}_{0} & ( 1 )\end{matrix}$$
where p is an integer, f_{ADC} is a sampling frequency of the optical fiber sensor, c is a speed of light in the optical fiber represented as c=c₀/n_{c} when c₀ is a speed of light in vacuum and n_{c} is a refractive index of a core of the optical fiber, and d₀ is an interval between discrete points in a spatial direction, and
t is a measurement time, and is represented as
$$\begin{matrix}[ Mathematical formula 58 ] & \\ t = q \times \frac{1}{{f}_{pulse}} & ( 2 )\end{matrix}$$
where, when q is an integer and f_{Pulse} is a frequency at which a pulse of the laser light is emitted,
the first gauge length G is represented as G=Nd₀,
the second gauge length g is represented as g=nd₀,
N is an integer, and n is an integer less than N, and
p and q are determined from p₀≤p≤p₁, q₀≤q≤q₁,
in the step of taking the spatial difference data of the phase difference signal at the position shifted by the first gauge length,
when
Δφ(p,q)
is the phase difference signal of the backscattered light of the laser light at the first gauge length, and [symbol]
(p,q)
is the phase difference data of the backscattered light of the laser light at the second gauge length,
from
$$\begin{matrix}[ Mathematical formula 59 ] & \\ f ( p , q ) = Δφ ( p , q ) - Δφ ( p - n , q ) = ( p , q ) - ( p - N , q ) & ( 3 )\end{matrix}$$
$$\begin{matrix}[ Mathematical formula 60 ] & \\ - f ( p + N , q ) = - Δφ ( p + N , q ) + Δφ ( p + N - n , q ) = - Δφ ( p + N , q ) + Δφ ( p , q ) & ( 4 )\end{matrix}$$
the spatial difference data F(p,q) is obtained to be defined as
$$[ Mathematical formula 61 ]$$
$$F ( p , q ) = \frac{[ f ( p , q ) - f ( p + N , q ) ]}{2} = ( p , q ) - \frac{( p - N , q )}{2} - \frac{( p + N , q )}{2} , \qquad ( 5 )$$
in the step of specifying a position of the signal source in the predetermined section,
$$[ Mathematical formula 62 ]$$
$${F}_{mul} ( P ) = - {\sum }_{q = {q}_{0}}^{{q}_{1}} f ( p , q ) f ( p + N , q ) \qquad ( 6 )$$
is defined, and
from
$$[ Mathematical formula 63 ]$$
$${F}_{mul} ( P ) = {\sum }_{q = {q}_{0}}^{{q}_{1}} [ ( p , q ) - ( p - N , q ) ] [ ( p , q ) - ( p + N , q ) ] \approx {\sum }_{q = {q}_{0}}^{{q}_{1}} ( p , q ) , \qquad ( 7 )$$
Pₘₐₓ at which
Fₘᵤₗ(P)
takes a maximum value is obtained from
$$[ Mathematical formula 64 ]$$
$${arg max}_{{p}_{0} \leq p \leq {p}_{1}} {F}_{mul} ( P ) = {P}_{max} \approx {arg max}_{{p}_{0} \leq p \leq {p}_{1}} {\sum }_{q = {q}_{0}}^{{q}_{1}} ( p , q ) , \qquad ( 8 )$$
and
in the step of filtering the dummy signal,
a window function
$$[ Mathematical formula 65 ]$$
$$g ( p ) = \{ \begin{matrix}1 - {sin}^{2} & \frac{π ( p - {p}_{max} )}{N} \\ 0 , & Otherwise\end{matrix} , \vert p - {p}_{max} \vert < \frac{G}{2} \qquad ( 9 )$$
is used to obtain the phase difference data of the backscattered light of the laser light at the second gauge length represented as
$$[ Mathematical formula 66 ]$$
$$( p , q ) \approx g ( p ) F ( p , q ) . \qquad ( 10 )$$

9. A non-transitory computer readable medium having recorded thereon a program to cause a signal processing apparatus to execute:
a step of acquiring a phase difference signal of backscattered light of laser light, by an optical fiber sensor configured to convert dynamic distortion of an optical fiber, at a first gauge length that is a predetermined section, into a phase difference of the backscattered light of the laser light passing through the first gauge length; and
a step of obtaining phase difference data of the backscattered light of the laser light at a second gauge length shorter than the first gauge length, from the acquired phase difference signal of the backscattered light of the laser light.

10. The non-transitory computer readable medium having recorded thereon the program according to claim 9, wherein
the step of obtaining the phase difference data of the backscattered light of the laser light at the second gauge length includes
a step of calculating spatial difference data indicating a spatial difference of a phase difference signal at a position shifted in a longitudinal direction of the optical fiber, and
a step of removing a dummy signal from the spatial difference data.

11. The non-transitory computer readable medium having recorded thereon the program according to claim 10, wherein
the step of calculating the spatial difference data includes a step of taking the spatial difference data of the phase difference signal at a position shifted by the first gauge length, and
the step of removing the dummy signal includes a step of specifying a position of a signal source in the predetermined section and filtering the dummy signal.

12. The non-transitory computer readable medium having recorded thereon the program according to claim 11, wherein
in order to determine the first gauge length,
when d is a distance of the optical fiber from the optical fiber sensor to a measurement point, and is represented as
$$[ Mathematical formula 67 ]$$
$$d = p \times \frac{c}{2 \times {\int }_{ADC}} = p \times {d}_{0} \qquad ( 1 )$$
where p is an integer, f_{ADC} is a sampling frequency of the optical fiber sensor, c is a speed of light in the optical fiber represented as c=c₀/n_{c} when c₀ is a speed of light in vacuum and n_{c} is a refractive index of a core of the optical fiber, and d₀ is an interval between discrete points in a spatial direction, and
t is a measurement time, and is represented as
$$[ Mathematical formula 68 ]$$
$$t = q \times \frac{1}{{f}_{pulsε}} \qquad ( 2 )$$
where, when q is an integer and f_{Pulse} is a frequency at which a pulse of the laser light is emitted,
the first gauge length G is represented as G=Nd₀,
the second gauge length g is represented as g=nd₀,
N is an integer, and n is an integer less than N, and
p and q are determined from p₀≤p≤p₁, q₀≤q≤q₁,
in the step of taking the spatial difference data of the phase difference signal at the position shifted by the first gauge length,
when
Δφ(p,q)
is the phase difference signal of the backscattered light of the laser light at the first gauge length, and [symbol]
(p,q)
is the phase difference data of the backscattered light of the laser light at the second gauge length,
from
$$[ Mathematical formula 69 ]$$
$$f ( p , q ) = Δφ ( p , q ) - Δφ ( p - n , q ) = ( p , q ) - ( p - N , q ) \qquad ( 3 )$$
$$and$$
$$[ Mathematical formula 70 ]$$
$$- f ( p + N , q ) = - Δφ ( p + N , q ) + Δφ ( p + N - n , q ) = - ( p + N , q ) - ( p , q ) , \qquad ( 4 )$$
the spatial difference data F(p,q) is obtained to be defined as
$$[ Mathematical formula 71 ]$$
$$F ( p , q ) = \frac{[ f ( p , q ) - f ( p + N , q ) ]}{2} = ( p , q ) - \frac{( p - N , q )}{2} - \frac{( p + N , q )}{2} , \qquad ( 5 )$$
in the step of specifying a position of the signal source in the predetermined section,
$$[ Mathematical formula 72 ]$$
$${F}_{mul} ( P ) = - {\sum }_{q = {q}_{0}}^{{q}_{1}} f ( p , q ) f ( p + N , q ) \qquad ( 6 )$$
is defined, and
from
$$[ Mathematical formula 73 ]$$
$${F}_{mul} ( P ) = {\sum }_{q = {q}_{0}}^{{q}_{1}} [ ( p , q ) - ( p - N , q ) ] [ ( p , q ) - ( p + N , q ) ] \approx {\sum }_{q = {q}_{0}}^{{q}_{1}} ( p , q ) , \qquad ( 7 )$$
Pₘₐₓ at which
Fₘᵤₗ(P)
takes a maximum value is obtained from
$$[ Mathematical formula 74 ]$$
$${arg max}_{{p}_{0} \leq p \leq {p}_{1}} {F}_{mul} ( P ) = {P}_{max} \approx {arg max}_{{p}_{0} \leq p \leq {p}_{1}} {\sum }_{q = {q}_{0}}^{{q}_{1}} ( p , q ) , \qquad ( 8 )$$
and
in the step of filtering the dummy signal,
a window function
$$[ Mathematical formula 75 ]$$
$$g ( p ) = \{ \begin{matrix}1 - {sin}^{2} & \frac{π ( p - {p}_{max} )}{N} \\ 0 , & Otherwise\end{matrix} , \vert p - {p}_{max} \vert < \frac{G}{2} \qquad ( 9 )$$
is used to obtain the phase difference data of the backscattered light of the laser light at the second gauge length represented as
$$[ Mathematical formula 76 ]$$
$$( p , q ) \approx g ( p ) F ( p , q ) . \qquad ( 10 )$$
